(19) United States
(12) Patent Application Publication
(10) Pub. No.: US 2007/0266835 A1
(43) Pub. Date: Nov. 22, 2007

(54) RECONFIGURABLE SAW TABLE

(76) Inventor: Kelce S. Wilson, Murphy, TX (US)

Correspondence Address: KELCE WILSON, 1205 TERRACE MILL DRIVE, MURPHY, TX, 75094, US

(21) Appl. No.: 11/435,606

(22) Filed: May 17, 2006

(51) Int. Cl. B23D 45/02

(52) U.S. Cl. 83/486.1

(57) ABSTRACT

A saw table is described, which allows for rapid changes between cross-cutting and ripping configurations. Embodiments comprise a two-sided cutting surface, one for cross cutting, the other for ripping. A first fence protrudes from an edge of the surface only on the cross cut side, providing a guide for cross cuts and an obstruction-free surface for ripping. A second fence may be provided in the saw parking area, which is available for ripping. Embodiments may be used with or without an underlying table. If used with an underlying table, embodiments will absorb wear, delaying replacement and realignment of the underlying table. An underlying table may also remain available, if needed for high precision cuts. The cutting surface thickness may approximate the height of the fence on an underlying table, so that the cutting surface, parking area and top of the underlying fence comprise a roughly flush surface for ripping.

### TECHNICAL FIELD

The invention relates generally to woodworking and industrial power tools, and more particularly, to providing a cutting table surface that can be rapidly reconfigured to allow changes in the position of an alignment guide or rapid selection among multiple alignment guides.

### BACKGROUND OF THE INVENTION

Radial arm saws typically have a wooden table which comprises a cutting surface, an alignment fence, and a parking surface area behind the fence, and is attached firmly to the frame beneath the saw. While the saw blade is in the parking area behind the fence, an object that is to be cut may be placed on the cutting surface and pushed firmly against the fence. The fence is positioned precisely with respect to the saw blade cutting path, so that holding an object firmly against the fence will align the object for an accurate cut. The saw is then turned on, and the rotating blade moves through the fence and over the cutting surface, where it cuts the object. The blade typically passes entirely through the object that is being cut and protrudes into the cutting surface

Proper table alignment and condition is critical to the accuracy of a radial arm saw. Table misalignment, damage or warping will spoil the accuracy of the cuts. As a result, tables require carefully-machined pieces, which must be periodically replaced due to aging and use. Because of the required precision, saw tables can be relatively expensive. In addition to the expense, installing a new table also requires a time-consuming alignment process.

A radial arm saw is capable of multiple types of cuts, such as standard 90-degree cross cuts, miter cuts, bevel cuts and ripping. For the standard cuts, miter cuts, and bevel cuts, the saw blade must typically pass through the fence, from the parking surface to the cutting surface, or in the reverse direction. As a result, the fence must have a notch for each point where the blade passes through. Additionally, since the blade must often cut entirely through an object, the cutting surface itself will be scored by the blade along the cutting path. The scores in the table due to standard, miter and bevel cuts will be straight lines from the parking surface, through the fence, and into the cutting surface.

If a saw is used for only standard cuts, 45-degree miter cuts and 45-degree bevel cuts, the fence will have three notches, and the cutting surface will be scored along three lines. If however, the saw is used for multiple miter or bevel cut angles, the fence will have more notches and the cutting surface will have more scores. Eventually, the fence and cutting surface may accumulate enough notches and scores that they can no longer be used to align objects accurately.

For rip cuts, the saw motor is brought out in front of the fence, rotated, such that the blade is parallel to the fence, and fixed in place with respect to the fence. When the saw is turned on, the object to be cut is pressed against the fence and moved across the table laterally into the rotating saw blade. For ripping, the object moves, sliding along the fence, while the blade remains fixed. Since the blade must often cut entirely through an object, it will score the table beneath the blade. The scores in the table caused by ripping, however, are not the same as those for cross cuts. The scores from ripping are arced troughs, roughly in the middle of the table. Eventually, an accumulation of multiple troughs will damage the table enough to require table replacement.

Another concern for rip cuts is the span of the rip. The saw can only produce a finished, ripped piece that is as wide as the distance between the fence and the blade. Often, this distance may not be sufficient. As a result, some radial arm saw tables are designed to allow the fence and parking surface to be swapped, which increases the distance between the fence and the blade. If the width of the finished piece does not require swapping the fence and parking surface, this procedure may be avoided. However, if this procedure is needed, it presents some problems. It is not a trivial process to swap the fence and parking surface, and each time it is done, it allows for the possibility of misaligning the fence when the fence is returned to its original position. Any misalignment in the fence will result in the notches being widened the next time the blade passes through the fence for a cross cut. Widened notches may require replacement of the fence, even sooner than the cutting surface requires replacement. Additionally, the notches in a fence, that result from cross cuts, provide possible snag points when an object is slid along the fence for ripping.

### BRIEF SUMMARY OF THE INVENTION

Embodiments of the invention provide for a rapidly reconfigurable saw table comprising a cutting surface and a first fence that is attached to the cutting surface and protrudes on only one side. The first fence allows for object alignment on the standard cross cut side, and an obstruction-free surface on the ripping side. The table may be oriented with the first fence protruding upward for standard cross cuts or protruding downward for rip cuts. When the first fence protrudes upward, it is available for aligning objects to be cut, similar to a standard radial arm saw fence. When the first fence protrudes downward, a wider, level cutting surface is provided, because the first fence does not interfere with the ripping surface. A second fence may then be provided on the back side of the parking area, or at any other suitable location in the parking area. Since the second fence may remain in position, there is no need to swap a fence and parking surface in order to provide an alignment guide for ripping. Additionally, since the second fence is not used for cross cuts, there will not be any notches that could snag an object that is sliding along the second fence during a rip cut.

Embodiments of the invention may provide for an alignment mechanism that allows rapid reversal of the cutting surface between the standard cross cut side and the ripping side, while preserving table alignment in either configuration. For example, the table may further comprise alignment pins and alignment holes. The alignment holes may be counter-sunk on both sides of the table, such that the alignment pins do not protrude when either of the cutting surfaces is facing upward. Changing from standard cross cuts to ripping may only require disengaging the alignment pins, inverting the cutting surface, and reengaging the alignment pins. This process takes only a matter of seconds, and is considerably faster than swapping a fence and parking surface.

Embodiments of the invention may provide for placing the reconfigurable table on top of a standard table, and may further provide for alignment pins engaging the standard table. In this manner, the alignment of the standard table provides the basis for the alignment of the reconfigurable table. Further, a second parking surface may be provided, and placed on top of the standard parking surface, allowing for a parking surface that is level with the reconfigurable table cutting surface. The reconfigurable table cutting surface and second parking surface may have a thickness that approximates the height by which a standard fence protrudes above the standard cutting surface. In this manner, when the reconfigurable cutting surface is oriented for ripping, and placed against the standard fence for alignment, the reconfigurable cutting surface, top of the standard fence and second parking surface will present a roughly flush surface.

Embodiments of the invention allow for alignment pins to be placed through a standard table, abutting against the edges of a standard table, engaging another part attached to the saw frame, or attached to the saw frame itself. When the reconfigurable table requires replacement, it may be possible to simply set a new one in place over top of the standard table, without the time-consuming alignment procedure necessary when replacing a standard table. A pre-drilled reconfigurable table may reduce the precision of the cuts below what is possible with a custom-aligned standard table. However, the use of a reconfigurable table along with a standard table permits use of the standard table for situations in which the reconfigurable table's precision may not be adequate. For high precision cuts, the reconfigurable table may be removed, and the standard table may be used normally. For cuts that do not require such high precision, a less-expensive reconfigurable table may absorb most of the wear and tear from use, which would prolong the life of the standard table. Embodiments of the invention, however, may not require the presence of a standard table, but may allow a reconfigurable table to be used as the sole table.

### BRIEF DESCRIPTION OF THE DRAWINGS

For a more complete understanding of the present invention, reference is now made to the following descriptions taken in conjunction with the accompanying drawings, in which:

FIG. 1 shows a prior art standard table set up for standard cross, miter and bevel cuts;

FIG. 2 shows a prior art standard table set up for wide ripping;

FIG. 3 shows an embodiment of the invention set up for standard cross, miter and bevel cuts;

FIG. 4 shows an embodiment of the invention set up for wide ripping; and

FIG. 5 shows a method for using an embodiment of the invention.

### DETAILED DESCRIPTION OF THE INVENTION

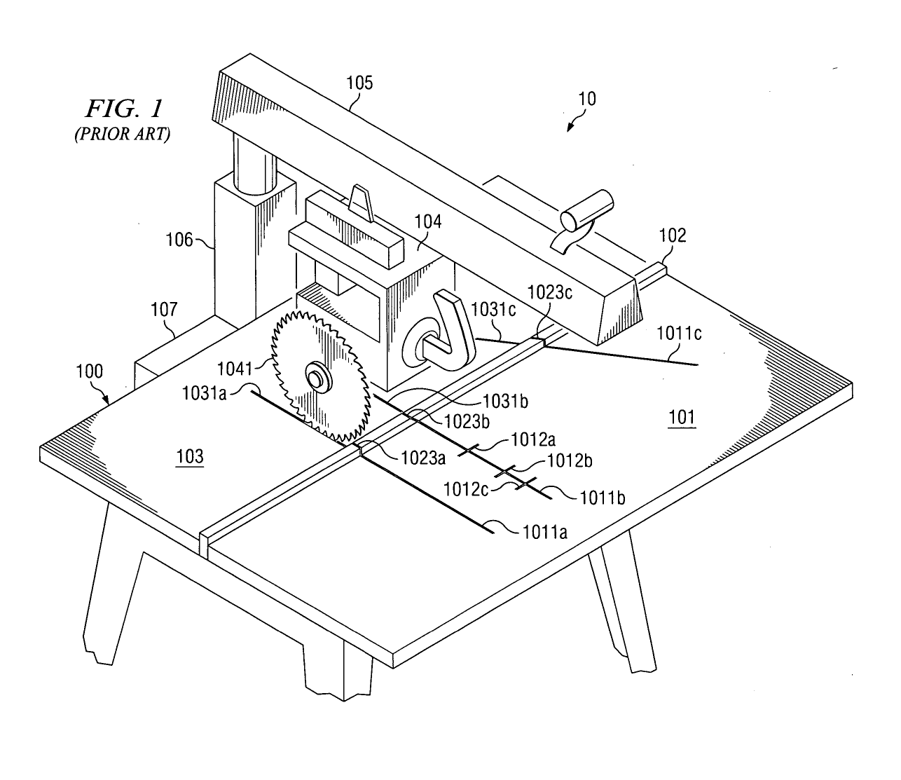

FIG. 1 shows radial arm saw 10 with a prior art standard table 100, comprising standard cutting surface 101, standard fence 102 and standard parking surface 103. Cutting surface 101 has both scores 1011a-c and troughs 1012a-c as a result of contact with the saw blade. Fence 102 has notches 1023a-c, and parking surface 103 has scores 1031a-c. Fence 102 is between cutting surface 101 and parking surface 103. Saw motor 104 rides on radial arm 105, which is attached to post 106. Post 106 is attached to frame 107. Saw blade 1041 is shown protruding into parking surface 103 in score 1031a, such that when saw 104 is moved along arm 105, blade 1041 will pass through notch 1023a and protrude into score 1011a. In FIG. 1, prior art standard table 101 is set up for standard cross, miter and bevel cuts, and may also be used for narrow ripping.

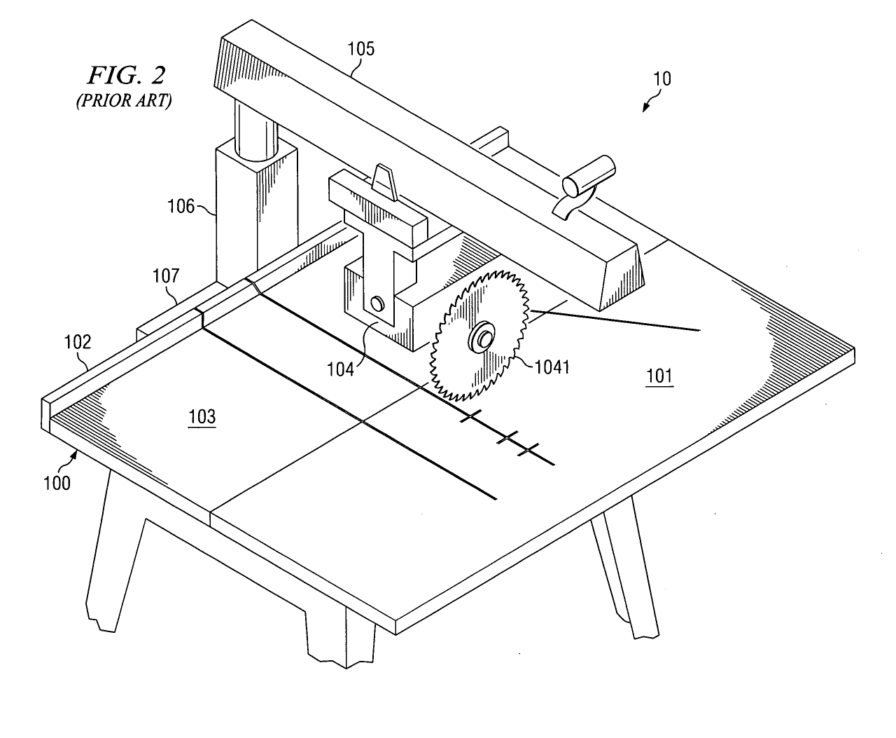

FIG. 2 also shows saw 10 with prior art standard table 100, but configured for wide ripping. In FIG. 2, parking surface 103 is between cutting surface 101 and fence 102. This configuration allows for more distance between saw blade 1041 and fence 102. Saw motor 104 is oriented for ripping, since blade 1041 is parallel to fence 102.

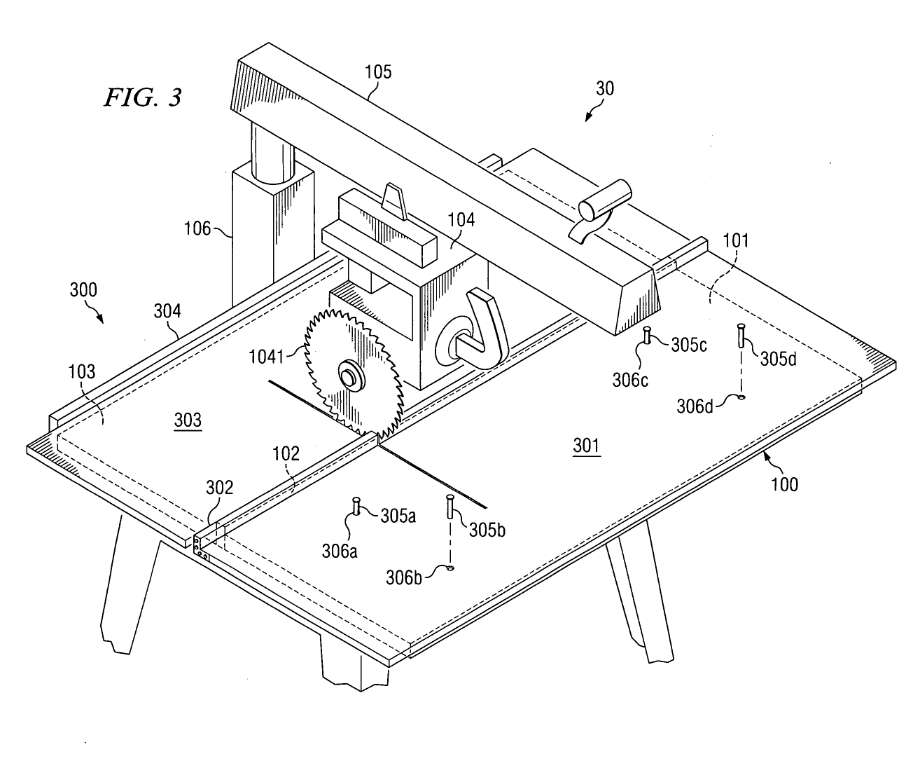

FIG. 3 shows radial arm saw 30 with rapidly reconfigurable saw table 300, comprising two-sided cutting surface 301, first fence 302, second parking surface 303 and second fence 304. Table 300 is shown set on top of standard table 100 (shown in dashed lines). That is, cutting surface 301 is set on top of standard cutting surface 101 (shown in dashed lines), and parking surface 303 is set on top of standard parking surface 103 (shown in dashed lines). First fence 302 abuts standard fence 102 (shown in dashed lines) for alignment, and is permanently affixed to cutting surface 301, such that cutting surface 301 and first fence 302 move together. Cutting surface 301 is held in place using alignment pins 305a-d, which engage standard cutting surface 101. Parking surface 303 and second fence 304 are also aligned against standard fence 102. Thus, the alignment of standard table 100 provides the basis for aligning rapidly reconfigurable saw table 300. Alternatively, table 300 could attach directly to frame 107, shown in FIGS. 1 and 2, such that an underlying table, such as standard table 100, is not needed.

Holes 306a-d are countersunk so that the tops of alignment pins 305a-d do not protrude above the level surface of cutting surface 301. For clarity, alignment pin 305b is shown out of hole 306b. In FIG. 3, reconfigurable saw table 300 is set up for standard cross, miter and bevel cuts, because first fence 302 protrudes upward. In this configuration, table 300 may also be used for narrow ripping.

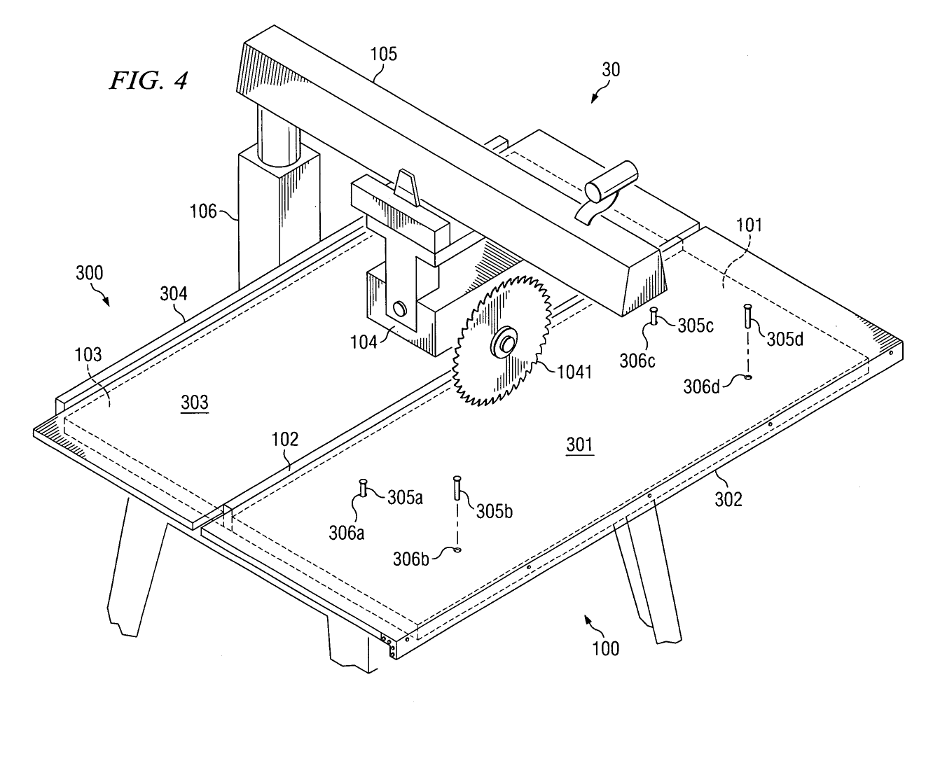

FIG. 4 shows radial arm saw 30 with rapidly reconfigurable saw table 300 configured for wide ripping. In FIG. 4, cutting surface 301 is oriented such that first fence 302 protrudes downward, in front of standard table 100 (shown in dashed lines). This is possible, because cutting surface 301 is sufficiently deep to enable fence 304 to drape down in front of cutting surface 101 (shown in dashed lines). Cutting surface 301 is aligned against standard fence 102, and held in place using alignment pins 305a-d. The top of standard fence 102 is visible between cutting surface 301 and parking surface 303. Cutting surface 301, top of standard fence 102, and parking surface 303 provide a roughly flush surface. Second fence 204 provides alignment for ripping, but since it is not also used for cross cuts, second fence 204 does not have any notches that might snag an object being ripped. Holes 306a-d are also countersunk on the ripping side, so that the tops of alignment pins 305a-d do not protrude on the ripping side.

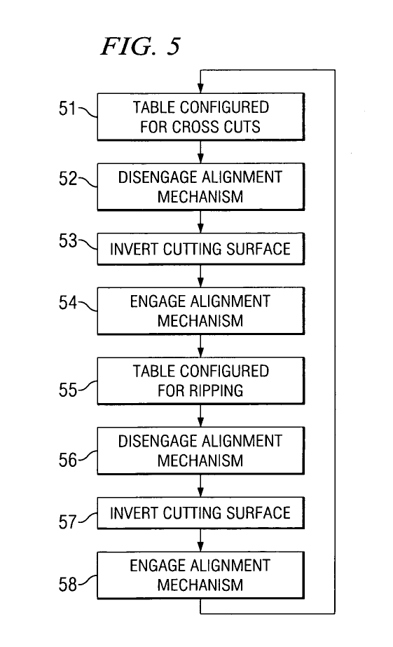

FIG. 5 shows a method for using an embodiment of the invention. At box 51, the saw table is configured for standard cross, miter and bevel cuts. An alignment mechanism that retains a cutting surface in proper position is disengaged in box 52. For example, alignment pins may be removed from holes, although another alignment mechanism may be used without departing from the scope of the invention. In box 53, the cutting surface is inverted and set back on the saw, such that the fence used for cross cutting protrudes downward. An alignment mechanism is engaged in box 54, to hold the cutting surface in place. At box 55, the table is configured for ripping.

The method may also be used starting at box 55, if the table is configured for ripping. An alignment mechanism that retains a cutting surface in proper position is disengaged in box 56. In box 57, the cutting surface is inverted and set back on the saw, such that a fence protrudes upward. An alignment mechanism is engaged in box 58, to hold the cutting surface in place. At box 51, the table is configured for standard cross, miter and bevel cuts. The cutting surface may also be placed with a fence facing up, but on the front operator side of standard the cutting surface, such that fence provides a guide between the saw blade and the operator. This may provide a safety ridge.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A reconfigurable saw table for use with a power saw, the table comprising:
a cutting surface comprising a first cutting side and a second cutting side opposite said first cutting side, wherein said cutting surface is configured to be invertible relative to the saw; and
a first fence attached to said cutting surface, said first fence protruding from said cutting surface on said first side.

2. The table of claim 1 further comprising:
a parking surface, said parking surface sized to provide a surface level with said cutting surface.

3. The table of claim 2 further comprising:
a second fence protruding above said parking surface, wherein said second fence is configured to remain in place when said cutting surface is inverted.

4. The table of claim 2 wherein said second cutting side of said cutting surface and said parking surface are sized to provide a roughly flush surface with a top of a fence of an underlying saw table.

5. The table of claim 1 wherein said first fence does not protrude upwardly from said second cutting side while the second cutting side faces upwardly.

6. The table of claim 1 further comprising:
an alignment mechanism whereby said cutting surface is configured to be fixed in position with either said first cutting side or said second cutting side disposed for holding objects that are to be cut.

7. The table of claim 6 wherein said alignment mechanism comprises pins and holes.

8. The table of claim 6 wherein a side that is disposed for holding objects that are to be cut faces upward.

9. The table of claim 6 wherein said first fence protrudes upward from said cutting surface when said first cutting side faces upward, and said first fence protrudes downward when said second side faces upward.

10. The table of claim 1 wherein said cutting surface is configured to be aligned by placing said first fence parallel to a fence of an underlying table.

11-19. (canceled)

20. The table of claim 1 wherein said cutting surface is configured to be aligned by placing said first fence adjacent to a fence of an underlying table.

21. The table of claim 1 wherein said cutting surface is further configured to be rotated relative to the saw, while said first cutting side remains facing upwardly.

22. The table of claim 4 wherein said parking surface is on an opposite side of said fence of said underlying saw table from said cutting surface.

23. The table of claim 1 wherein said saw is a radial arm saw.

24. A table for use with a power saw, the table comprising:
a cutting surface comprising a first cutting side and a second cutting side opposite said first cutting side,
wherein said cutting surface is configured to be invertible relative to the saw, such that said first cutting side faces upwardly beneath the saw when said second cutting side faces downwardly and said first cutting side faces downwardly beneath the saw when said second cutting side faces upwardly;
wherein a first fence protrudes upwardly from said cutting surface when said first cutting side faces upwardly;
and wherein said cutting surface and said first fence are configured to provide an obstruction-free surface when said second cutting side faces upwardly.

25. The table of claim 24 wherein said first fence is permanently affixed to said cutting surface.

26. The table of claim 24 wherein a second fence is coupled to a parking surface, and wherein said parking surface is configured to form a flush surface with said second cutting side when said second cutting side faces upwardly.

27. A removable table for use with an underlying power saw table, the removable table comprising:
a cutting surface comprising a first cutting side and a first fence, wherein said first fence protrudes upwardly from said cutting surface when said first cutting side protrudes upwardly, and wherein said cutting surface is configured to be aligned by aligning said first fence parallel to a fence of said underlying table

28. The removable table of claim 27 further comprising a second cutting side opposite said first cutting side, wherein said cutting surface and said first fence are permanently affixed and are configured to provide an obstruction-free surface when said second cutting side faces upwardly and said first cutting side faces downwardly.
